(19) United States
(12) Patent Application Publication
(10) Pub. No.: US 2004/0018789 A1
(43) Pub. Date: Jan. 29, 2004

(54) Molded parts with discontinuous fabric surface areas and processes for their production

(76) Inventors: Eric L. Marchbanks, Linwood, MI (US); Curt E. Peterson, Midland, MI (US); Todd A. DeMint, Kalamazoo, MI (US); Ari P. Kinnunen, Lahti (FI); Kenneth T. Bennick, Three Rivers, MI (US); Thomas E. Van Conett, Saginaw, MI (US); Michael E. Hus, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/208,394

(22) Filed: Jul. 29, 2002

(51) Int. Cl. B32B 5/18; B29C 45/14

(52) U.S. Cl. 442/221; 442/370; 442/394; 442/286; 264/511; 264/275

(57) ABSTRACT

The present invention thus provides a fabric-laminated plastic part and a novel process where the fabric that provides the surface is pre-laminated with a support layer and supplied into a molding process where a plastic substrate component is molded. The fabric surface piece is precisely located and securely bonded by selection of a support layer plastic material having sufficient heat resistance and/or thickness to sufficiently resist melt softening and stretching during the molding process. This process and fabric laminated plastic article are especially suited for preparing thin-wall, articles that need to have precisely located, smooth fabric surface areas corresponding to discontinuities, voids or openings in the underlying molded plastic article.

This invention relates to injection molded plastic parts having fabric surface areas in or around areas where there are discontinuities (e.g., voids, openings, contours and the like) at the surface of the part. The molded plastic enclosures of many types of articles need to have openings, gripping surfaces and similar sorts of discontinuous surface areas for purposes of key pads, buttons, switches, displays, aesthetics, etc. This invention provides such parts with an attractive and sturdy fabric surface and a process for making these parts where the fabric edges are precisely located and secured in a very effective and aesthetically pleasing manner. Parts are produced with good appearance, precise dimensions, thin part cross section and stable, secure fabric edge coverings.

### BACKGROUND OF THE INVENTION

There are a number of processes for providing a surface layer of a fabric, such as leather or simulated leather, onto all or part of the surface of molded plastic parts. Using an injection molding process and pre-inserting a fabric surface piece in front of or into the mold is discussed in JP 54-018,039; JP 57-029,436; DE 4,015,071; EP 1,157,799; and U.S. Pat. No. 4,849,145.

DE 4,015,071 and JP 57-029,436 teach the use of a film layer between the fabric and the injected, molten plastic. In EP 1,157,799 a thermoformable plastic film is pre-laminated to the fabric and then a shaped preform is prepared by forming the laminated material, for example by a deep drawing process, to correspond generally to the finished part surface design. Then the preform is inserted into the injection mold where the molten plastic is injected behind the fabric/foil laminate pre-form to form a part having all or part of the design layer as the outer surface of the finished part.

However, none of the prior art references teach an efficient and effective technique for preparing thin-wall, molded articles that have precisely located fabric surfaces with smooth fabric surface areas that are intended to have discontinuities, voids or openings (i.e., non-linear fabric edges) corresponding to discontinuities, voids or openings in the underlying molded plastic article. Instead, the fabric surface areas resulting from these methods tend to be wrinkled and/or require subsequent process steps to provide the voids or openings in the fabric and/or the underlying plastic article. In addition, none of the prior art references teach a method for precisely locating fabric in a finished molded article as to eliminate the need for secondary operations. The problems with the fabric surfaces are especially pronounced in low modulus, elastic fabrics that are more easily stretched or compressed in molding step(s).

### SUMMARY OF THE INVENTION

In one embodiment the present invention is a process for preparing a molded plastic article comprising a substrate plastic component with discontinuities or voids and a fabric surface area with discontinuities or voids corresponding and aligned to those in the substrate plastic component comprising the steps of: (a) laminating to the back side of a fabric a support layer, (b) cutting or shaping the laminated fabric to generally conform to the shape and size of a desired fabric surface area and incorporating discontinuities or voids to correspond to those in the plastic substrate component, (c) inserting the shaped laminated fabric piece from step (b) into a molding cavity with the discontinuities and/or voids properly aligned with the mold surface and holding the piece in place, and (d) molding the plastic substrate component in the molding cavity, and (e) removing the molded plastic article from the mold. Preferably the support layer is laminated to the fabric using an intermediate adhesive polymer which is preferably an EVA (ethylene vinyl acetate) polymer adhesive. In other preferred embodiments, the support layer comprises polycarbonate and/or there is a foamed plastic layer between the fabric piece and the support layer and/or the fabric is a synthetic leather or suede. In an alternative embodiment, the present invention is also a molded article prepared according to the previous process embodiments.

The present invention thus provides a better fabric-laminated plastic part and a novel process and part design where a high quality, precisely located, smooth fabric surface is provided in a fast and efficient process. The fabric can be selected from a wide range of fabric types and laminated to the support layer. The fabric laminate is then precut, stamped and/or otherwise shaped to desired size. The laminated fabric piece is inserted into a mold cavity by hand or any generally known mechanical/robotic means and is adhered to plastic substrate component that is injected into the mold cavity to provide a fabric-laminated piece for further process steps or assembly to a finished product with an aesthetically pleasing and durable fabric covering. Proper selection of the combination of the support layer material, the plastic substrate material and the fabric provides the necessary processability and rigidity to prevent the fabric material from damage or distortion during the molding process and sufficient adhesion to resist delaminating or peeling off the molded part during use.

### BRIEF DESCRIPTION OF THE DRAWINGS

FIG. 1 is a perspective view of the front side of a sample part prepared according to the invention.

FIG. 2 is a cross sectional view of a sample part prepared according to the invention taken across the line A-B in FIG. 1.

### DETAILED DESCRIPTION

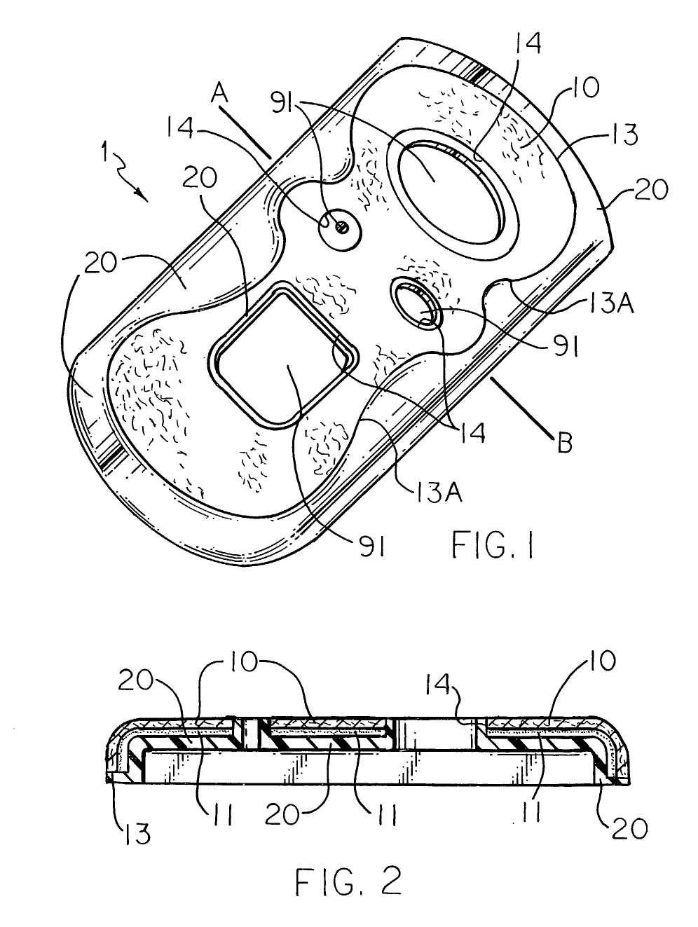

The FIG. 1 perspective view and FIG. 2 cross sectional view (not to scale)of a sample part according to the invention (1) show the fabric surface piece (10) and the thin support layer (11) that was pre-laminated to the fabric. The fabric surface area has peripheral fabric edges (13) at the outer edges of the fabric surface piece and interior fabric edges (14) where there are voids in the fabric surface piece that correspond with voids (91) at corresponding locations in the plastic part. Also shown in FIGS. 1 and 2 is the substrate component (20), in this case extending beyond and not entirely covered by the fabric piece. There are voids or openings of various shapes and sizes (91) in the plastic part and the fabric and a discontinuous or irregular peripheral fabric edge section (13A). Both of these cases require careful, proper location and fixing of the fabric piece in the mold cavity and are highly subject to fabric surface defects due to flow forces on these fabric edge areas.

Fabric Surface Material

A wide range of fabric materials can be used for the fabric surface area of this invention. This is a tremendous advantage of the parts and process that are provided according to the present invention. The suitable fabric materials include but are not limited to: natural and synthetic leathers (including both leathers and suedes) and any types of textiles or textile-like materials such as, woven, non-woven, and knit fabrics from natural or synthetic fibers/materials including coagulated polyurethane laminates, PVC and other flexible film or sheet materials. The suitable “fabrics” may include laminates and structures combining two or more of these and the use of one or more of these with an adhered “backing material”. Though the subsequent lamination of the support layer usually makes them unnecessary, “backing materials” may be present in commercially available fabrics or added to the fabric if needed to adhere better to the support layer, stiffen the fabric and/or prevent the plastic from being excessively forced into or through the back of the fabric. Backing materials can include a wide range of natural or synthetic materials or textiles including woven, non-woven, and knit fabrics from natural or synthetic fibers/materials, and foams, films or sheets of a plastic material.

In one embodiment of the present invention, a foam layer can advantageously be included as a backing material for the fabric piece or an intermediate layer between the fabric surface piece and the support layer. When using a compressible type of foam, this can provide or enhance the soft or cushioned feel of the fabric surface. This layer can be present on the fabric that is supplied for use or can be laminated to a fabric either during the lamination of the support layer or prior to the support layer lamination. In general, the foam can be open or closed cell and needs to be sufficiently heat resistant to retain its desired properties during the subsequent processing steps, for example not melting or collapsing to an unacceptable degree. Suitable foam densities are in the range of from about 5 to about 95 kilograms per cubic meter (kg/m³), preferably from about 20 to about 75 kg/m³, depending upon their layer thickness and degree of cushion or compression that is desired. The plastic material used in the foam can be a thermoset or thermoplastic and preferred foam plastic layers include a foamed thermoset polyurethane.

Bonding of the backing material to the fabric can be achieved by flame lamination, adhesive bonding, electromagnetic radiation bonding, or thermally initiated adhesive such as Dow Adhesive Film.

Support Laver

In the first step of the process according to the present invention, the selected fabric is then laminated on the back side surface (i.e., the side opposite to the one desired for the surface of the finished part) with a support layer. As mentioned above, an intermediate foam layer can also be applied depending upon the look and feel desired for the part. In general, the support layer is desirably a thin sheet, film or layer of a plastic material having sufficient heat resistance and/or thickness to sufficiently resist melt softening and stretching during the molding process. The process or technique for laminating the thin sheet or layer is not critical as long as it provides a generally continuous layer on the fabric and does not detrimentally affect the fabric or its front side surface to a degree that it is unusable or undesirable for the surface of the finished article. Bonding of the support layer to the fabric (or, where used, the fabric backing or foam layer) can be achieved, for example, by flame lamination, adhesive bonding, electromagnetic radiation bonding, or thermally initiated adhesives such as films or layers of ethylene vinyl acetate, low temperature thermoplastic polyurethane, polyethylene, polypropylene, copolyester, copolyamide, ethylene acrylic acid, and including blends or laminates of two or more of these materials.

In general, the material for the thin support layer, the lamination process and the lamination adhesives (if necessary) bonded to the fabric are selected to obtain sufficient adhesion combinations with the fabric and the plastic substrate material. Additionally, the support layer of plastic material, is selected to provide sufficient rigidity during the molding process to minimize the fabric wrinkling and, more importantly, the fabric stretch during molding. This typically means that during the molding process, the full thickness of the support layer is not heat softened and maintains a sufficient degree of rigidity to preclude fabric wrinkling and stretching. In general, the full thickness of the support layer should not exceed the Tg (glass transition temperature) for amorphous thermoplastic plastic material or the Tm (crystalline melting point) for semi-crystalline plastic materials during the molding process. Sufficient adhesion between fabric and the support layer material is needed to avoid delamination during the subsequent processing and handling to cut and mold the fabric piece. The adhesion in the molded part between the fabric, support layer of plastic material and plastic substrate material is critical to maintain a finished part where the fabric cannot be separated during subsequent assembly of a finished product employing the fabric-surfaced molded structure or during the use of the finished product.

Suitable materials for the support layer of plastic material obviously depend upon the plastic substrate material that is used and include, for example thermoset plastics such as polyurethane, epoxy or thermosetting silicone and thermoplastics based on or comprising polymers such as polycarbonates (“PC”), ABS, polypropylene (“PP”), high impact polystyrene (“HIPS”), polyethylene (“PE”), polyester (e.g., PET), polyacetyl, thermoplastic elastomers, thermoplastic polyurethanes (“TPU”), nylon, ionomer (e.g., Surlyn), polyvinyl chloride (“PVC”) and including blends of two or more of these thermoplastics such as PC and ABS or such as PC, ABS and TPU.

Desirably, the support layer plastic material is at least as heat resistant as, and is preferably more heat resistant that, the substrate component plastic material. In amorphous thermoplastics, this means having a Tg that is equal to or preferably higher, while in crystalline or semicrystalline thermoplastics, this means having a melting point or crystalline melting point that is equal to or preferably higher.

The selection of the support layer material and the molding/processing temperature for preparing the plastic substrate will determine how thick the support layer needs to maintain sufficient rigidity of the laminated fabric piece during molding. In general the support layer thickness should be in the range of from about 0.0005 inches to about 0.05 inches (0.013 to 1.3 millimeters or mm), preferably from about 0.001 to about 0.01 inches (0.025 to 0.25 mm), more preferably from about 0.003 to about 0.007 inches (0.076 to 0.178 mm). For example, for a PC support layer and a PC/ABS substrate component, the support layer thickness should be in the range of from about 0.001 inches to about 0.01 inches (0.025 to 0.25 mm). For a PET support layer, component, the support layer thickness should be in the range of from about 0.001 inches to about 0.01 inches (0.025 to 0.25 mm).

As needed for facilitating fabrication of the part and providing the desired dimensions, shapes, irregularities, voids, openings, and the like, the fabric surface piece (pre-laminated with the support layer) can then be cut or shaped as needed. This means that such fabric piece can be cut, stamped out, shaped, formed and/or preformed by known techniques such the known deep drawing processes for preparing pre-formed shapes to be inserted into the mold. Depending upon the design of the finished article, there can obviously be different fabric types used in different surface sections of the article.

Plastic Substrate Component

In general, the substrate component can be prepared from a broad range of plastic materials including thermoset plastics such as polyurethane, epoxy or thermosetting silicone and thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (e.g., Surlyn), polyvinyl chloride (“PVC”) and including blends of two or more of these thermoplastics such as PC and ABS. These materials may contain pigments, additives and/or fillers that contribute any needed cost and/or performance features such as surface appearance, ignition resistance, modulus, toughness, EMI shielding and the like. It should also be noted that depending upon selection of the substrate and support layer of plastic material and the thickness of the support layer material, there may or may not be a detectable layer of boundary between the support layer material and the substrate component plastic material layer.

The plastic substrate component can be prepared by generally known molding techniques that are suited to provide the necessary plastic substrate or base part having the fabric surface piece properly located and sufficiently adhered. A preferred molding technique is injection molding by preparing pre-cut fabric piece that can be properly located and sufficiently fixed to an inner mold surface in an injection molding mold during the injection molding process. In the injection molding step molten plastic is injected into the mold, filling the mold, conforming the laminated fabric piece to the mold shape and simultaneously bonding the laminated fabric piece to the substrate component. Other suitable processes for forming the substrate and/or attaching the fabric include thermoforming, injection compression molding, gas assist injection molding, structural foam injection molding, microcellular foam molding technology, laminar injection molding, water injection molding, external gas molding, shear controlled orientation molding, and gas counter pressure injection molding.

Thermosetting or thermosetable plastics can also be employed to similarly prepare the plastic substrate component using known techniques for reaction injection molding or resin transfer molding.

In injection molding the plastic substrate molding step according to a preferred embodiment of the invention, there are at least two mold parts. The first mold part can be referred to as a “core” and the second as a “cavity”. The cut out and/or shaped fabric surface piece 10 is placed in the mold, usually the cavity section, and is generally held by vacuum against the inside surface of the cavity. Then the plastic component material 20 is injected. (See FIG. 1.) The fabric piece is placed into the mold by hand, robotic or other known means that is capable of accurately locating and aligning the void area edges and the irregular edges to correspond with their desired location on the surface of the molded article. The fabric piece is obviously placed into the mold such that the side of the fabric desired on the molded article surface is against the mold cavity wall and the side with the support layer plastic material is facing the open mold cavity and the injected plastic will flow against and contact that layer.

The molten plastic material for the substrate component is injected into the mold through an injection gate at a rate and pressure sufficient to fill the mold, completely cover the back side of the fabric piece, compress the fabric piece against the cavity mold surface and adhere the injected plastic to the support layer plastic material on the back side of the fabric piece.

The mold surface of the cavity for molding the plastic substrate can be textured to any known surface finish that is desired for any lamination/adhesion to its surface in a subsequent step or for the appearance or texture of the exposed portions of the fabric or substrate plastic material. Then, during the injection step the plastic enters the mold, filling the mold, conforming the fabric piece to the mold shape and imparting the mold surface/grain/texture onto the fabric and/or substrate material surface.

### EXAMPLES

A part according to the present invention as generally shown in FIG. 1 was designed and produced as follows. A non-woven polyester fabric was laminated to a polycarbonate film 0.005 inches (approx. 0.13 mm) thick by the use of a thermally initiated ethylene vinyl acetate (EVA) adhesive film commercially available from The Dow Chemical Company as Integral 801 brand film. The lamination was conducted at 220 degrees C. (set-point temperature for heating the rolls) on a two-roll laminator. The resulting laminate was pre-cut to the desired size and shape (including internal openings) and inserted into the desired location between the cavity and the core on an injection mold. Placement required careful alignment such that the fabric openings and their edges aligned with the mold surfaces where there would be openings and peripheral fabric edges aligned with their desired locations. The desired fabric front surface is placed against the cavity and held in place by the use of vacuum. The plastic substrate material, a PC/ABS blend, is injected into the mold coming in contact with the PC film. The flow of the injected PC/ABS provides pressure and heat to the back side of the laminated fabric, sufficient to form the fabric to the shape of the cavity surface. Upon removal of the part from the mold and its evaluation, it can be seen that the fabric surface is properly located at all edge areas, tightly and securely adhered to the PC/ABS thermoplastic substrate and has not been distorted, wrinkled or otherwise damaged as the plastic substrate material was injected and filled the mold.

In comparison, the use of the same fabric without pre-lamination of the PC film results in the pre-cut fabric significantly stretching, wrinkling and shifting within the mold during the filling and packing stage of molding. The fabric surface in the cooled and ejected plastic part has dimensions that are significantly different than the desired dimensions and substantially different than those of the pre-cut fabric.

What is claimed is:

1. A process for preparing a molded plastic article comprising a substrate plastic component with discontinuities or voids and a fabric surface area with discontinuities or voids corresponding and aligned to those in the substrate plastic component comprising the steps of: (a) laminating to the back side of a fabric a support layer, (b) cutting or shaping the laminated fabric to generally conform to the shape and size of a desired fabric surface area and incorporating discontinuities or voids to correspond to those in the plastic substrate component, (c) inserting the shaped laminated fabric piece from step (b) into a molding cavity with the discontinuities and/or voids properly aligned with the mold surface and holding the piece in place, and (d) molding the plastic substrate component in the molding cavity, and (e) removing the molded plastic article from the mold.

2. The process according to claim 1 wherein the support layer is laminated to the fabric using an intermediate adhesive polymer.

3. The process according to claim 2 wherein the adhesive polymer is a(n) EVA (ethylene vinyl acetate) polymer adhesive.

4. The process according to claim 1 wherein the support layer comprises polycarbonate.

5. The process according to claim 1 wherein the shaped fabric piece is held in place in the mold cavity by one or more vacuum ports.

6. The process according to claim 1 wherein the substrate plastic material is a thermoplastic selected from the group consisting of polycarbonate (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomers, polyvinyl chloride (“PVC”) and blends of two or more of these thermoplastics.

7. The process according to claim 1 wherein there is a foamed plastic layer between the fabric piece and the support layer of plastic material.

8. The process according to claim 1 wherein the fabric is a synthetic leather or suede.

9. A molded article prepared according to claim 1.

10. A molded article according to claim 9 wherein the fabric is a synthetic leather or suede.

11. A molded article according to claim 9 wherein there is a foamed plastic layer between the fabric piece and the support layer of plastic material.

12. A molded article according to claim 11 wherein the foam is an open celled foam.
